(19) United States
(12) Patent Application Publication
(10) Pub. No.: US 2009/0019766 A1
(43) Pub. Date: Jan. 22, 2009

(54) House Watering System (Base Bud)

(76) Inventor: Helen Adams, Modesto, CA (US)

Correspondence Address: WILSON DANIEL SWAYZE, JR., 3804 CLEARWATER CT., PLANO, TX, 75025, US

(21) Appl. No.: 11/778,224

(22) Filed: Jul. 16, 2007

(51) Int. Cl. A01G 25/14

(52) U.S. Cl. 47/79

(57) ABSTRACT

A house watering system for watering a plant with the fluid includes an exterior housing including a rigid top member for housing the house watering system, and an interior housing having a flexible sidewall for supplying the house watering system with the fluid. The rigid top member supports the plant, and the flexible side wall allows the fluid to be pressurized and supply the plant with the fluid. The house watering system includes a sealable opening member to allow the fluid to be replaced and to be sealed, and the house watering system includes an adjustable plant feed valve to adjust the fluid flow from the interior housing.

### FIELD OF THE INVENTION

The present invention relates to a watering device for plants which are grown in the home or in a greenhouse and more particularly, to an improved automatic watering device to provide for the automatic watering of the plants.

### BACKGROUND

There are many types of automatic plant watering apparatus which are well known in the prior art which utilize a system which is actuated in response to water loss by the plants. However, these apparatus suffer from a number of disadvantages such as, for example, they require complex mechanisms to operate and they are difficult to install in that a variety of complex apparatus are required to assemble them. Furthermore, they are provided with an elevated water reservoir with a spring loaded valve therein which is actuated by the loss of weight of water by the plants in a container supported by the spring. Since the springs lose their strength as the temperature increases, plants are frequently overwatered on hot days. In addition, there are several types of apparatus which utilizes a counter weight member in such as disclosed in U.S. Pat. No. 4,060,934. Such apparatus, however, are used with a plant container which must be placed on the floor or ground. They cannot be utilized with plant containers which must be hung from a ceiling, a wall or the like.

U.S. Pat. No. 4,760,666 discloses a watering device for plants which includes a plant container which is balanced on a horizontal pivot rod by an adjusting weight member. A water reservoir tank is operatively associated with the plant container so that as the plant container becomes lighter as to a loss of water. The adjusting weight member disposed at the opposite end of the horizontal pivot rod from the plant container actuates a valve in the water reservoir tank and transfer water from the water reservoir tank to the plant container until a balance is again achieved. When the balance is reached, the valve in the water tank is again closed.

### SUMMARY

A house watering system for watering a plant with the fluid includes an exterior housing including a rigid top member for housing the house watering system, and an interior housing having a flexible sidewall for supplying the house watering system with the fluid.

The rigid top member supports the plant, and the flexible side wall allows the fluid to be pressurized and supply the plant with the fluid.

The house watering system includes a sealable opening member to allow the fluid to be replaced and to be sealed, and the house watering system includes an adjustable plant feed valve to adjust the fluid from interior housing.

The adjustable plant feed valve is adjusted by a plant feed knob, and the exterior housing includes a rigid bottom member to support the house watering system.

The rigid top member is connected to the rigid bottom member by an arm; the arm moves along a first track which is positioned along a side of the rigid top member; and the arm moves along a second track positioned along a side of the rigid bottom member.

The arm is connected to a track guide to cooperate with the track.

The present invention is directed to a manual pump machine for a house watering system that will care for watering house plants regularly without the help of the owner. The house watering system will not require frequent refilling and may go without refilling for as long as two weeks or a month. The house watering system does not require any external energy and should operate smoothly and regularly by only placing the plant to be watered on the top of the house watering system. The weight of the plant will push down on the house watering system which will in turn cause water out of the plant feed valve.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an external housing and internal housing of the house watering system of the present invention in a first position;

FIG. 2 illustrates the external housing and the internal housing of the house watering system of the present invention in a second position;

FIG. 3 illustrates the internal housing of the house watering system of the present invention in the first position;

FIG. 4 illustrates the internal housing of the house watering system of the present invention in the second position;

FIG. 5 illustrates the house watering system of the present invention being used by a flower pot.

### DETAILED DESCRIPTION

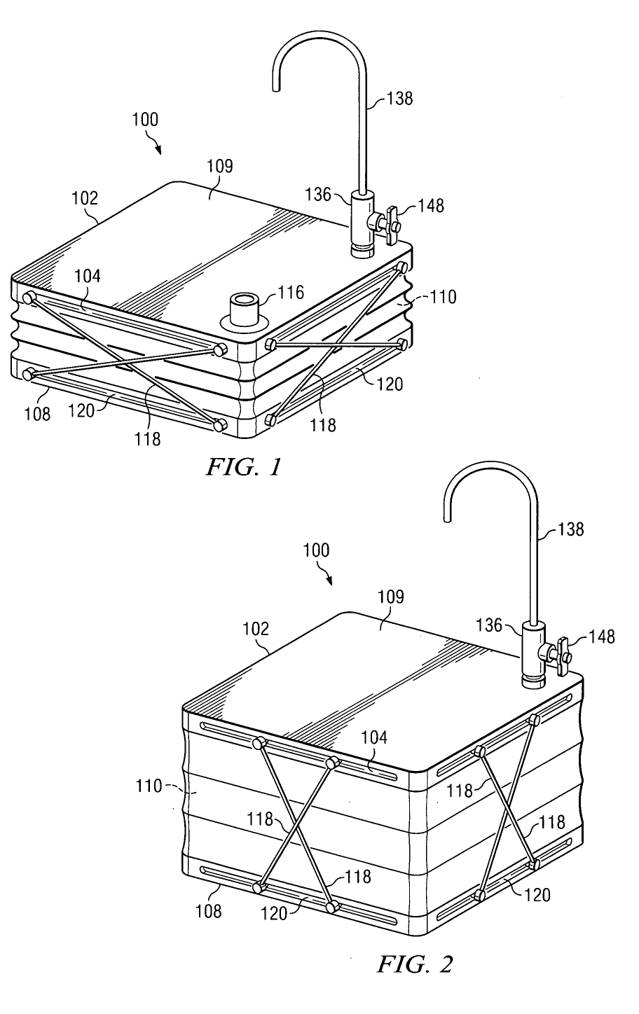

FIG. 1 illustrates the external housing 102 and the internal housing 110 of the house watering system 100 of the present invention. The external housing 102 includes a rigid top member 109 to support the flower pot and a rigid bottom member 108 to support the house watering system 100. Both the rigid top member 109 and the rigid bottom member 108 includes a track 104 along each side of the rigid top member 109 and the rigid bottom member 108 to guide a track guide 120 along the track 104. The track guide 120 is connected to rigid arm members 118 which may be crossed to maintain the rigid top member 109 and the rigid bottom member 108 in a spaced relationship with respect to each other.

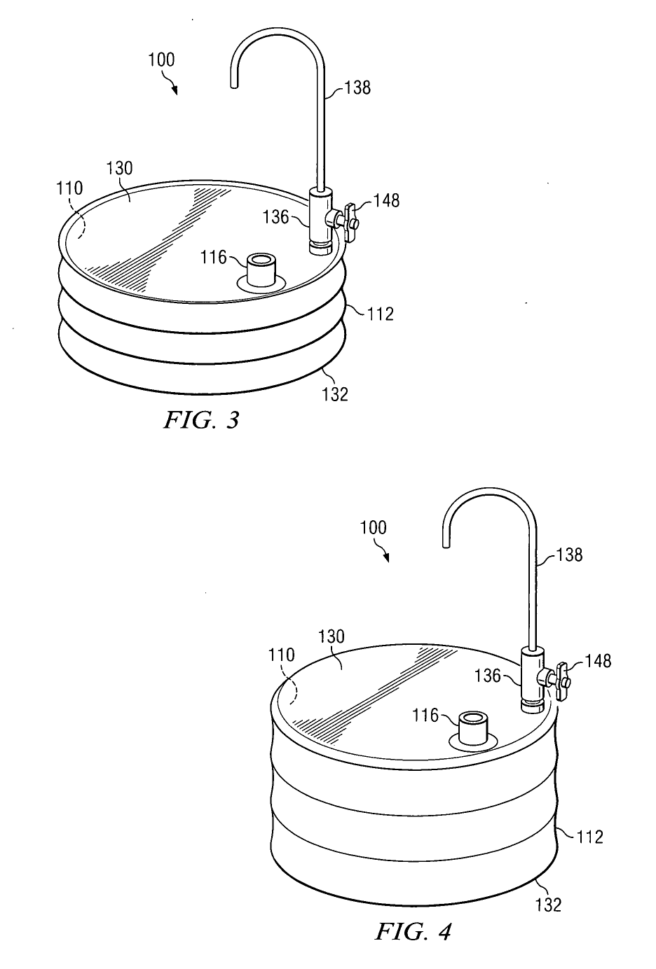

FIG. 3 illustrates the interior housing 110 which includes a flexible top member 130, a flexible bottom member 132 and a flexible sidewall member 112 which extends from the flexible top member 130 to the flexible bottom member 132 and extends around the perimeter of the flexible top member 130 and the perimeter of the flexible bottom member 132. The interior housing 110 will contain the fluid that will be delivered to the flower pot; consequently, the interior housing 110 should be flexible and retain the fluid or be waterproof. The fluid may be water or a combination of water and chemicals which are beneficial for the flowers. The flexible top member 130 includes a sealable opening member 116 which includes a sealable opening in order to allow the fluid to be replaced within the interior housing 110 and then the opening can be sealed in order to maintain pressure of the fluid within the interior housing 110. The flexible top member 130 additionally includes a plant feed valve 136 which is adjustable by a plant feed knob 148 to adjust the plant feed valve 136 to increase or decrease the amount of fluid which flows to the plant. The plant feed valve 136 is connected to a plant feed line 138 which is shown as a substantially inverted U-shaped member in order to deposit the fluid on the plant. The plant feed valve 136 and the seal sealable opening member 116 extends through apertures in the rigid top member 104 of the external housing 102.

FIGS. 1 and 3 illustrates the house watering system 100 in a compressed state where the fluid has been removed from the internal housing 110 through the plant feed valve 136 and through the plant feed line 138. The ends of the rigid arms 118 are extended apart in the track 104 to allow the exterior housing 102 and the interior housing 110 to be compressed.

FIGS. 2 and 4 illustrate the house watering system 100 in an extended state where the internal housing 100 is a substantially filled with fluid so that when the user opens the plant feed valve 136 by the plant feed knob 148 the pressure due to the plant and vase 502 on the rigid top member 104 causes the fluid to flow through the plant feed line 138 and onto the plant and vase 502. The ends of the arms 118 are positioned towards each other and closer to the center of the track 104 in order to support the rigid top member 109 and the rigid bottom member 108.

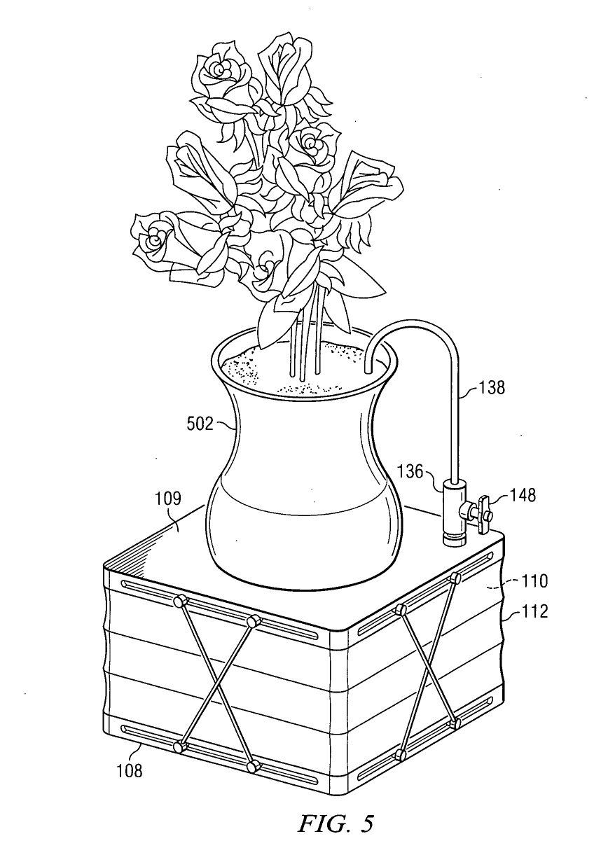

FIG. 5 illustrates the plant feed line 138 supplying water or other fluid to the plant and vase 502. The rate of the fluid flow is controlled by the plant feed valve 136 which is adjusted by the plant feed knob 148. The weight of the plant and vase 502 is exerted on a rigid top member 109 which in turn compresses the interior housing 110 causing pressure on the fluid which allows the fluid to flow from the plant feed line 138 on to the plant and vase 502.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A house watering system for watering a plant with the fluid, comprising:
an exterior housing including a rigid top member for housing the house watering system;
an interior housing having a flexible sidewall for supplying the house watering system with the fluid;
wherein the rigid top member supports the plant, and wherein the flexible side wall allow the fluid to be pressurized and supply the plant with the fluid.

2) A house watering system for watering a plant with the fluid as in claim 1, wherein the house watering system includes a sealable opening member to allow the fluid to be replaced and to be sealed.

3) A house watering system for watering a plant with the fluid as in claim 1, wherein the house watering system includes a adjustable plant feed valve to adjust the fluid flow from interior housing.

4) A house watering system for watering a plant with the fluid as in claim 3, wherein the adjustable plant feed valve is adjusted by a plant feed knob.

5) A house watering system for watering a plant with the fluid as in claim 1, wherein the exterior housing includes a rigid bottom member to support the house watering system.

6) A house watering system for watering a plant with the fluid as in claim 5, wherein the rigid top member is connected to the rigid bottom member by an arm.

7) A house watering system for watering a plant with the fluid as in claim 6, wherein the arm moves along a first track positioned along a side of the rigid top member.

8) A house watering system for watering a plant with the fluid as in claim 7, wherein the arm moves along a second track positioned along a side of the rigid bottom member.

9) A house watering system for watering a plant with the fluid as in claim 8, wherein the arm is connected to a track guide to cooperate with the track.
